(19) United States
(12) Patent Application Publication
(10) Pub. No.: US 2025/0029356 A1
(43) Pub. Date: Jan. 23, 2025

(54) INFORMATION PROCESSING APPARATUS, METHOD AND NON-TRANSITORY COMPUTER READABLE MEDIUM

(71) Applicant: KABUSHIKI KAISHA TOSHIBA, Tokyo (JP)

(72) Inventors: Yuichi KATO, Moriya Ibaraki (JP); Kentaro TAKAGI, Yokohama Kanagawa (JP); Kouta NAKATA

(73) Assignee: KABUSHIKI KAISHA TOSHIBA, Tokyo (JP)

(21) Appl. No.: 18/588,194

(22) Filed: Feb. 27, 2024

(30) Foreign Application Priority Data
Jul. 21, 2023 (JP) 2023-119243

(51) Int. Cl. G06V 10/44

(52) U.S. Cl. CPC G06V 10/44

(57) ABSTRACT

According to one embodiment, an information processing apparatus includes a processor. The processor acquires training data that is used for training of a first feature extractor and a second feature extractor. The processor determines a model size of the second feature extractor. The processor extracts a first feature by inputting the training data to the first feature extractor. The processor extracts a second feature by inputting the first feature to the second feature extractor. The processor trains the first feature extractor in such a manner as to make the first feature closer to the second feature.

### CROSS-REFERENCE TO RELATED APPLICATION

This application is based upon and claims the benefit of priority from prior Japanese Patent Application No. 2023-119243, filed Jul. 21, 2023, the entire contents of which are incorporated herein by reference.

### FIELD

Embodiments described herein relate generally to an information processing apparatus, method and non-transitory computer readable medium.

### BACKGROUND

In deep learning, in a natural language process and an image recognition process, a power law is confirmed in which a performance is improved in accordance with a model size. However, there is a problem that as the model size becomes larger, a memory and calculation cost at a time of inference become larger.

### BRIEF DESCRIPTION OF THE DRAWINGS

FIG. 1 is a block diagram illustrating an information processing apparatus according to a first embodiment.

FIG. 2 is a flowchart illustrating an operation example of the information processing apparatus according to the first embodiment.

FIG. 3 is a diagram illustrating a first example of a first feature extractor and a second feature extractor.

FIG. 4 is a diagram illustrating a second example of the first feature extractor and the second feature extractor.

FIG. 5 is a block diagram illustrating an information processing apparatus according to a second embodiment.

FIG. 6 is a flowchart illustrating an operation example of the information processing apparatus according to the second embodiment.

FIG. 7 is a block diagram illustrating an information processing apparatus according to a third embodiment.

FIG. 8 is a flowchart illustrating a first operation example of the information processing apparatus according to the third embodiment.

FIG. 9 is a flowchart illustrating a second operation example of the information processing apparatus according to the third embodiment.

FIG. 10 is a block diagram illustrating an example of a hardware configuration of the information processing apparatus.

### DETAILED DESCRIPTION

In general, according to one embodiment, an information processing apparatus includes a processor. The processor acquires training data that is used for training of a first feature extractor and a second feature extractor. The processor determines a model size of the second feature extractor. The processor extracts a first feature by inputting the training data to the first feature extractor. The processor extracts a second feature by inputting the first feature to the second feature extractor. The processor trains the first feature extractor in such a manner as to make the first feature closer to the second feature.

Hereinafter, an information processing apparatus, method and program according to embodiments are described in detail with reference to the accompanying drawings. In the embodiments below, it is assumed that parts with identical reference signs perform similar operations, and an overlapping description is omitted unless where necessary.

### First Embodiment

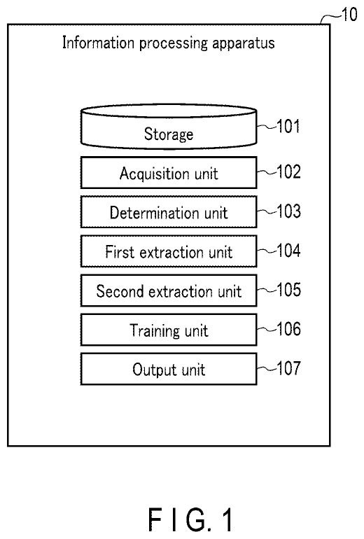

An information processing apparatus according to a first embodiment is described with reference to a block diagram of FIG. 1.

An information processing apparatus 10 according to the first embodiment includes a storage 101, an acquisition unit 102, a determination unit 103, a first extraction unit 104, a second extraction unit 105, a training unit 106, and an output unit 107.

The storage 101 stores a machine learning model (hereinafter, also referred to simply as “model”) including a first feature extractor and a second feature extractor, training data, and the like. It is assumed that the model is, for example, a ViT (Vision Transformer), a BERT (Bidirectional Encoder Representations from Transformer), a GPT (Generative Pretrained Transformer), or the like, each of these using a so-called Transformer configuration. Aside from the Transformer configuration, an MLP (Multi Layer Perceptron)-Mixer may be used, and it suffices to use such a configuration that the number of dimensions of the input to the model is equal to the number of dimensions of the output from the model. By this configuration, stacking of layers forming the model becomes easier.

In the present embodiment, a case in which training data is images is assumed, but the embodiment is not limited to this. For example, use may be made of one-dimensional time-series data such as control signal data, speech data, natural language data, music data and sensor values, or data of two or more dimensions, other than images, such as sign data, log data, moving picture data, table data, and transaction data.

The acquisition unit 102 acquires training data that is used for training of the first feature extractor and the second feature extractor.

The determination unit 103 determines a model size of the second feature extractor.

The first extraction unit 104 inputs the training data to the first feature extractor, and extracts a first feature.

The second extraction unit 105 inputs the first feature to the second feature extractor, and extracts a second feature.

The training unit 106 trains the first feature extractor in such a manner as to make the first feature closer to the second feature. Specifically, the parameters of the first feature extractor are updated. After the training ends, a trained first feature extractor is generated. Note that the parameters include, for example, a weight and a bias of a network.

The output unit 107 outputs the trained first feature extractor to, for example, an external apparatus.

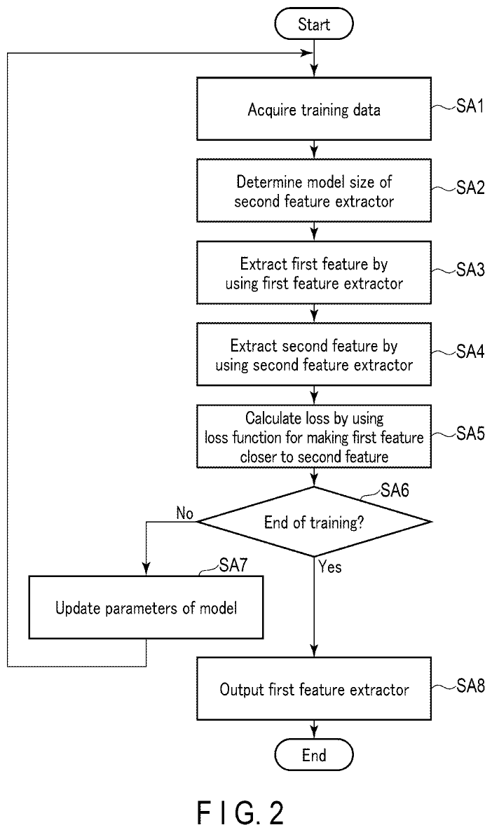

Next, an operation example of the information processing apparatus 10 according to the first embodiment is described with reference to a flowchart of FIG. 2.

In step SA1, the acquisition unit 102 acquires the training data from the storage 101.

In step SA2, the determination unit 103 determines the model size of the second feature extractor. The model size may be determined based on at least one of a size that is mountable in the memory size of a semiconductor chip (e.g., CPU/GPU/TPU), a calculation cost, and an inference accuracy. Specifically, if it is allowed that the memory size of the semiconductor chip of the computer is large and the calculation cost is large, the model size of the second feature extractor may be set to be large. In addition, in general, since the inference accuracy increases as the model size becomes larger, the model size of the second feature extractor may be determined so as to achieve a necessary inference accuracy.

In step SA3, the first extraction unit 104 extracts a first feature by using the first feature extractor. Specifically, the training data is input to the first feature extractor, and the first feature is extracted as an output of the first feature extractor.

In step SA4, the second extraction unit 105 extracts a second feature by using the second feature extractor. Specifically, the first feature is input to the second feature extractor, and a second feature is extracted as an output of the second feature extractor.

In step SA5, the training unit 106 calculates a loss by using a loss function for making the first feature closer to the second feature. For example, in a case where a first feature is vᵢ and a second feature is zᵢ in regard to i-th (i>0) training data, a loss L_{d} representing a distance between the first feature and the second feature can be expressed by equation (1). Here, N is the number of training data or the number of minibatches.

$${L}_{d} = \frac{1}{N} {\sum }_{i}^{N} {‖ {v}_{i} - {z}_{i} ‖}^{2} \qquad ( 1 )$$

In step SA6, whether the training of the first feature extractor has ended or not is determined. As regards the determination as to whether the training has ended or not, for example, if the loss L_{d} of the loss function of equation (1) is equal to or less than a threshold, it may be determined that the training has ended. Alternatively, if the width of decrease of the loss L_{d} has converged, it may be determined that the training has ended. Besides, if a predetermined epoch number of processes has ended, it may be determined that the training has ended. If the training ended, the process proceeds to step SA8, and if the training has not ended, the process proceeds to step SA7.

In step SA7, the training unit 106 updates the parameters of the model (here, the first feature extractor), for example, by a gradient descent method or an error backpropagation method, in such a manner that the loss L_{d} becomes minimum. Specifically, the training unit 106 updates the parameters, such as a weight and a bias of the network relating to the first feature extractor. After updating the parameters, the process returns to step SA1, and continues the training by using new training data. If the training is finally completed, the training of the first feature extractor is finished, and a trained first feature extractor (also referred to simply as “trained model”) is generated. By training the first feature extractor such that the loss L_{d} becomes minimum, the first feature can be made closer to the second feature.

In step SA8, the output unit 107 outputs the trained first feature extractor. The output unit 107 may output the trained first feature extractor, for example, to an external apparatus (not illustrated) such as a server, or may store the trained first feature extractor in the storage 101 of the information processing apparatus 10.

In the example of the flowchart of FIG. 2, the first feature and the second feature are compared. However, an MLP head may be connected to each of the first feature extractor and the second feature extractor, and, based on a prediction value obtained from the MLP head, the first feature may be made closer to the second feature.

Specifically, for example, a first feature vᵢ is input to an MLP head, and it is assumed that an output from the MLP head is v′ᵢ. A loss L₁ of the first feature extractor in this case can be expressed by equation (2).

$${L}_{1} = \frac{1}{N} {\sum }_{i}^{N} C E ( σ ( {v}_{i}^{′} ) , y ) \qquad ( 2 )$$

Here, CE is a cross entropy, σ is a softmax function, and y is a class label of training data.

Similarly, a second feature zᵢ is input to an MLP head, and it is assumed that an output from the MLP head is z′ᵢ. A loss L₂ of the second feature extractor in regard to the class label y of training data can be expressed by equation (3).

$${L}_{2} = \frac{1}{N} {\sum }_{i}^{N} C E ( σ ( {z}_{i}^{′} ) , y ) \qquad ( 3 )$$

Note that the parameters (weight, bias, etc.) of the MLP head connected to the first feature extractor and the parameters of the MLP head connected to the second feature extractor may be identical, or different parameters may be set.

A total loss L based on equations (1) to (3) can be set as indicated by equation (4).

$$L = α \cdot {L}_{1} + β \cdot {L}_{2} + γ \cdot {L}_{d} \qquad ( 4 )$$

Here, α, β, and γ are coefficients that determine the weights of the respective losses. By training the model such that the total loss L defined by equation (4) becomes smaller, the training unit 106 can train the first feature extractor in such a manner as to make the first feature closer to the second feature.

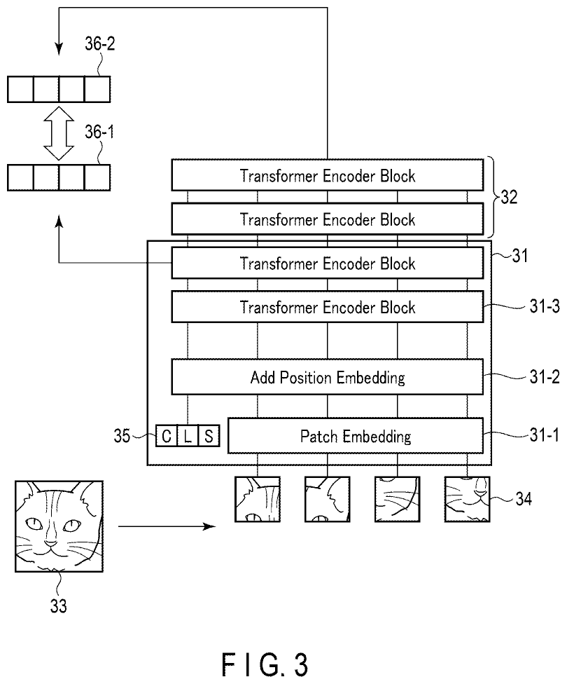

Next, referring to FIG. 3, a description is given of a first example of the first feature extractor and second feature extractor used in the information processing apparatus 10 according to the first embodiment.

A machine learning model illustrated in FIG. 3 includes a first feature extractor 31 and a second feature extractor 32. It is assumed that the first feature extractor 31 and second feature extractor 32 are constructed by the ViT.

The first feature extractor 31 includes a Patch Embedding 31-1, an Add Position Embedding 31-2, and one or more Transformer Encoder blocks 31-3.

Patch images 34, into which an image 33 is divided, are embedded in designated dimension numbers by the Patch Embedding 31-1. Next, by the Add Position Embedding 31-2, in regard to the patch image 34, position information indicating at which position in the entire image (input image 33) the patch image 34 is located, and a class token capable of learning, are embedded. As regards the class token 35, since a token generally used in the ViT is assumed, a detailed description is omitted.

Thereafter, the patch image in which the position information is embedded is processed by one or more Transformer Encoder blocks 31-3, and a first feature 36-1 is extracted. It can also be said that the first feature 36-1 is a feature from an intermediate layer. Note that since the Transformer Encoder block 31-1 itself is a block used in a general ViT, a detailed description of the operation is omitted.

The second feature extractor 32 includes one or more Transformer Encoder blocks 31-3. Since the second feature extractor 32 has the same configuration as the Transformer Encoder blocks 31-3 of the first feature extractor 31, the second feature extractor 32 can easily be stacked.

In the example of FIG. 3, the first feature extractor 31 and the second feature extractor 32 include the same number of Transformer Encoder blocks 31-3, namely two Transformer Encoder blocks 31-3. However, aside from this, each of the first feature extractor 31 and the second feature extractor 32 may include three or more Transformer Encoder blocks 31-3. Besides, the number of Transformer Encoder blocks 31-3 of the first feature extractor 31 may differ from the number of Transformer Encoder blocks 31-3 of the second feature extractor 32. Furthermore, the number of Transformer Encoder blocks 31-3 may be greater in either the first feature extractor 31 or the second feature extractor 32.

The first feature 36-1 that is output from the first feature extractor 31 is input to the Transformer Encoder blocks 31-3 of the second feature extractor 32, and the Transformer Encoder blocks 31-3 of the second feature extractor 32 output a second feature 36-2.

The training unit 106 may train, by using the above equation (1), the first feature extractor 31 in such a manner as to make the first feature 36-1 closer to the second feature 36-2. Thereby, at the time of training, the training can be executed in the state in which the second feature extractor 32 is connected, and at the time of inference, an inference with high accuracy can be executed by the first feature extractor 31 alone, without using the second feature extractor 32.

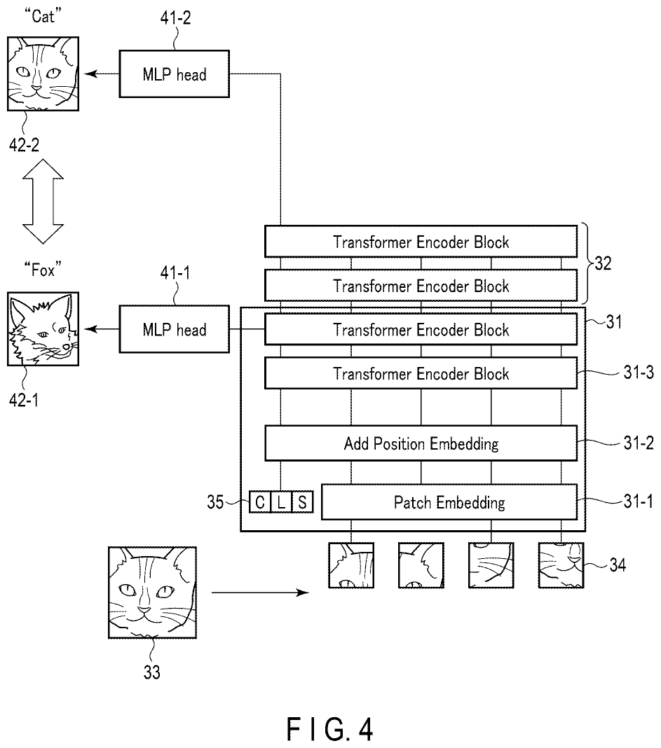

Next, referring to FIG. 4, a description is given of a second example of the first feature extractor and second feature extractor used in the information processing apparatus 10 according to the first embodiment.

FIG. 4 differs from FIG. 3 in that an MLP head 41-1 is connected to the first feature extractor 31, and an MLP head 41-2 is connected to the second feature extractor 32.

A first feature is input to the MLP head 41-1, and the MLP head 41-1 outputs a prediction value corresponding to a task. Here, a classification task is assumed, and an image of “Fox” is output as a prediction value 42-1 in regard to an input image “Cat”. On the other hand, a second feature is input to the MLP head 41-2, and the MLP head 41-2 outputs a prediction value corresponding to a task. Here, an image of “Cat” is output as a prediction value 42-2 in regard to the input image “Cat”.

Using the loss functions of the above equations (2) to (4), the training unit 106 trains the first feature extractor 31 in the state in which the second feature extractor 32 is connected, in such a manner as to make the prediction value 42-1 closer to the prediction value 42-2. In other words, the training may be performed such that the output of the class token relating to the second feature extractor 32 and the output of the class token relating to the first feature extractor 31 become closer to each other.

Note that as the class label y of equations (2) and (3), the input image 33 may be used. In addition, although the example of the classification task is illustrated here, aside from this, other tasks, such as an object detection task, an image generation task and an abnormality detection task, can similarly be executed.

According to the above-described first embodiment, the training data is input to the first feature extractor and the first feature extracted, and the first feature is input to the second feature extractor and the second feature is extracted, and the first feature extractor is trained in such a manner as to make the first feature closer to the second feature.

Specifically, training is performed by a large model in which the first feature extractor and the second feature extractor are connected, and at the time of inference, the second feature extractor is removed, and a small model of the first feature extractor alone is used. Thereby, by only the first feature extractor, a model having an equal inference accuracy to the large model can be generated. In other words, the performance can be improved while the model size is decreased.

### Second Embodiment

An information processing apparatus 10 according to a second embodiment differs from the first embodiment in that a pre-trained weight is used.

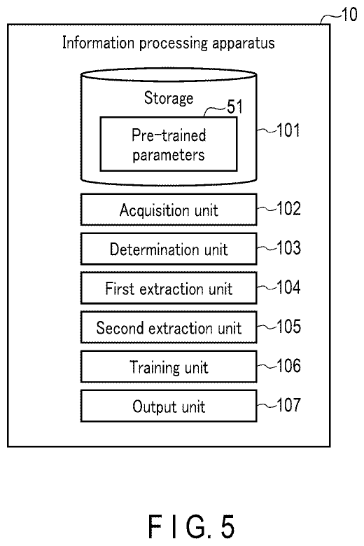

A block diagram of the information processing apparatus 10 according to the second embodiment is described with reference to FIG. 5.

The information processing apparatus 10 illustrated in FIG. 5 is similar to the information processing apparatus 10 illustrated in FIG. 1, except that pre-trained parameters 51 are stored in the storage 101, and so a description thereof is omitted. The pre-trained parameters are, for example, parameters, such as a weight or a bias, with respect to which the first feature extractor is pre-trained based on training data. As regards the second feature extractor, if initialized by a predetermined method, a part or the entirety of the second feature extractor uses pre-trained parameters.

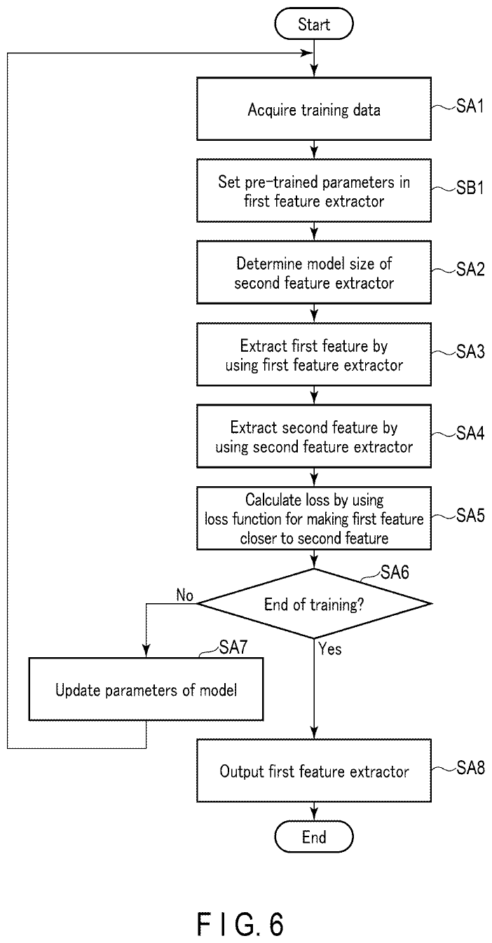

Next, an operation example of the information processing apparatus 10 according to the second embodiment is described with reference to a flowchart of FIG. 6.

Since step SA1 to step SA8 are similar to those in FIG. 2, a description thereof is omitted.

In step SB1, the determination unit 103 or the training unit 106 acquires pre-trained parameters from the storage 101, and sets the pre-trained parameters as parameters of the first feature extractor. Specifically, the training unit 106 determines the weight and bias from the pre-trained parameters.

According to the above-described second embodiment, the pre-trained parameters are set as the parameters of the first feature extractor. Thereby, since parameters having a certain inference accuracy in advance become initial values, the training time of the first feature extractor can be shortened, and a further improvement in inference accuracy can be expected.

### Third Embodiment

A third embodiment differs from the above-described embodiments in that a plurality of different second feature extractors are prepared.

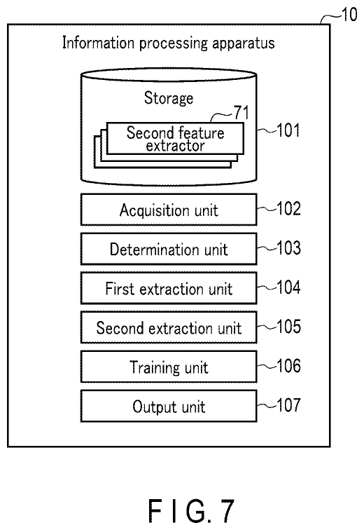

FIG. 7 illustrates a block diagram of an information processing apparatus 10 according to the third embodiment.

Since the information processing apparatus 10 illustrated in FIG. 7 is similar to the information processing apparatus 10 illustrated in FIG. 1, except for the processing in the storage 101 and the determination unit 103, a description thereof is omitted.

The storage 101 stores a plurality of second feature extractors 71. The stored second feature extractors 71 are mutually different with respect to at least either a model size or parameters such as a weight and a bias.

The determination unit 103 selects the second feature extractor that is connected to the first feature extractor, from among the second feature extractors stored in the storage 101.

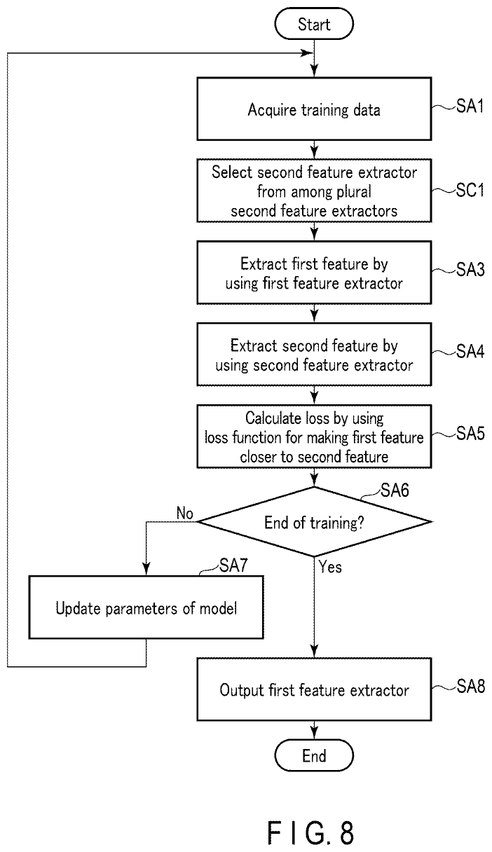

Next, a first operation example of the information processing apparatus 10 according to the third embodiment is described with reference to a flowchart of FIG. 8.

Since step SA1, and step SA3 to step SA8 are similar to those in FIG. 2, a description thereof is omitted.

In step SC1, the determination unit 103 selects the second feature extractor and connects the first feature extractor and the selected second feature extractor, thereby designing a model for training.

Thereby, since it suffices that the determination unit 103 selects the second feature extractor from the storage 101, it is not necessary for the determination unit 103 to calculate and determine, in the training process of the model, the model size and the like of the second feature extractor at each time.

In addition, a user may select the second feature extractor. For example, a calculation resource and cost are correlated with the second feature extractor of a model size corresponding to the calculation resource and cost. For example, information relating to this correlation is displayed on a GUI, and the user selects the second feature extractor corresponding to the desired calculation resource and cost, and thereby the determination unit 103 may select the second feature extractor in accordance with an instruction from the user.

Note that the first feature extractor may be trained by using a plurality of second feature extractors, and a plurality of first feature extractors for an ensemble may be generated.

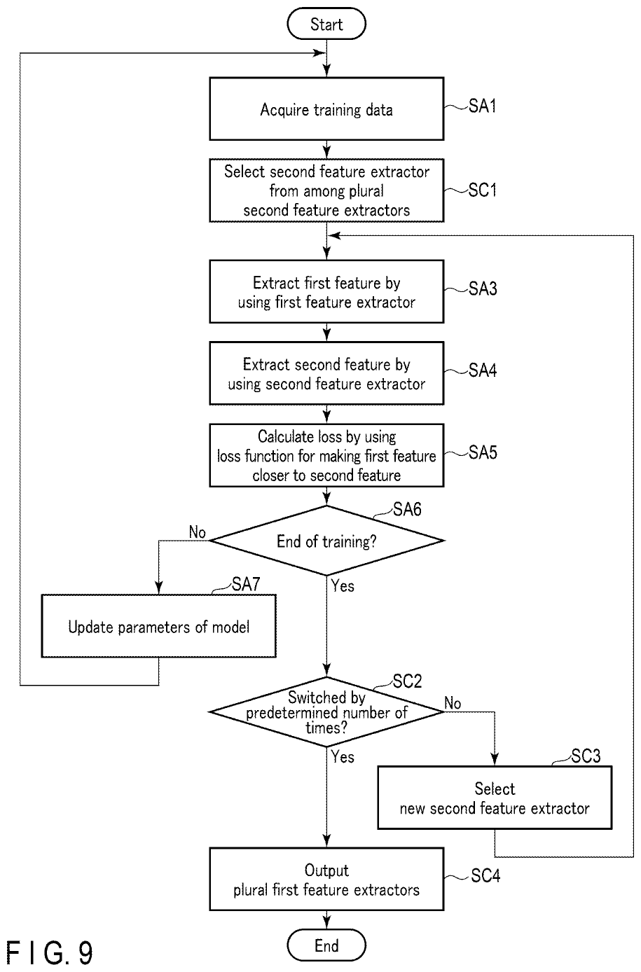

A second operation example of the information processing apparatus 10 according to the third embodiment is described with reference to a flowchart of FIG. 9.

Since step SA1, step SA3 to step SA7, and step SC1 are similar to those in FIG. 8, a description thereof is omitted.

In step SC2, it is determined whether the training unit 106 has switched the second feature extractor by a predetermined number of times. In other words, it is determined whether a predetermined number of second feature extractors are selected from the storage 101 and are trained. If the second feature extractor is switched by a predetermined number of times, the process proceeds to step SC4, and if the second feature extractor is not switched by a predetermined number of times, the process proceeds to step SC3.

In step SC3, the determination unit 103 selects a new second feature extractor, and connects the first feature extractor and the new second feature extractor, thereby designing the next model for training. Thereafter, the process of step SA3 to step SA7 is repeated, and the model is trained.

In step SC4, the output unit 107 outputs a plurality of trained first feature extractors. For example, at the time of inference, the inference accuracy can be improved by an ensemble process using a plurality of trained first feature extractors.

Note that in the third embodiment, the case was assumed that a plurality of second feature extractors are stored in the storage 101. Aside from this, a plurality of second feature extractors may be stored in an external apparatus such as a server, and the determination unit 103 may be configured to select and acquire the second feature extractor from the external apparatus.

In addition, in the case of a model with the same number of dimensions of features of each layer, like the ViT, since the number of stacked layers can easily be increased or decreased, such a model can appropriately be applied to, for example, federated learning. Specifically, a case is assumed in which the information processing apparatus 10 receives parameters that are transmitted from each client, and models are integrated and trained. At this time, the determination unit 103 can appropriately deploy the first feature extractor in which the model size is increased or decreased in accordance with the resource condition of the client.

According to the above-described third embodiment, a plurality of second feature extractors are stored in the storage, and the determination unit selects the second feature extractor that is used for training, from among the second feature extractors. Thereby, the model size is decreased and the performance of the model is improved, and furthermore there is no need to calculate and determine the model size and the like of the second feature extractor at each time of training.

Besides, the first feature extractor may be trained by using a plurality of second feature extractors, and first feature extractors for an ensemble may be generated. Thereby, the inference accuracy can further be improved.

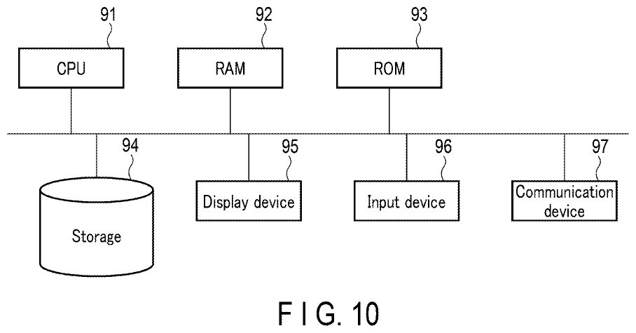

Next, an example of a hardware configuration of the information processing apparatus 10 according to each of the above-described embodiments is illustrated in a block diagram of FIG. 10.

The information processing apparatus 10 includes a CPU (Central Processing Unit) 91, a RAM (Random Access Memory) 92, a ROM (Read Only Memory) 93, a storage 94, a display device 95, an input device 96, and a communication device 97, and these components are connected by a bus.

The CPU 91 is a processor that executes an arithmetic process and a control process, or the like, in accordance with a program. The CPU 91 uses a predetermined area of the RAM 92 as a working area, and executes the above-described processes of the respective units of the information processing apparatus 10 in cooperation with programs stored in the ROM 93 and storage 94, or the like. Note that the processes of the information processing apparatus 10 may be executed by one processor, or may be executed by a plurality of processors in a distributed manner.

The RAM 92 is a memory such as an SDRAM (Synchronous Dynamic Random Access Memory). The RAM 92 functions as the working area of the CPU 91. The ROM 93 is a memory that stores programs and various information in a non-rewritable manner.

The storage 94 is a device that writes and reads data to and from a magnetic recording medium such as an HDD (Hard Disk Drive), a recording medium by a semiconductor such as a flash memory, a magnetically recordable storage medium such as an HDD, or an optically recordable storage medium. The storage 94 writes and reads data to and from the storage medium in accordance with control from the CPU 91.

The display device 95 is a display device such as an LCD (Liquid Crystal Display). The display device 95 displays various information, based on a display signal from the CPU 91.

The input device 96 is an input device such as a mouse and a keyboard, or the like. The input device 96 accepts, as an instruction signal, information that is input by a user's operation, and outputs the instruction signal to the CPU 91.

The communication device 97 communicates, via a network, with an external device in accordance with control from the CPU 91.

The instructions indicated in the processing procedures illustrated in the above embodiments can be executed based on a program that is software. A general-purpose computer system may prestore this program, and may read in the program, and thereby the same advantageous effects as by the control operations of the above-described information processing apparatus can be obtained. The instructions described in the above embodiments are stored, as a computer-executable program, in a magnetic disc (flexible disc, hard disk, or the like), an optical disc (CD-ROM, CD-R, CD-RW, DVD-ROM, DVD+R, DVD+RW, Blu-ray (trademark) Disc, or the like), a semiconductor memory, or other similar storage media. If the storage medium is readable by a computer or an embedded system, the storage medium may be of any storage form. If the computer reads in the program from this storage medium and causes, based on the program, the CPU to execute the instructions described in the program, the same operation as the control of the information processing apparatus of the above-described embodiments can be implemented. Needless to say, when the computer obtains or reads in the program, the computer may obtain or read in the program via a network.

Additionally, based on the instructions of the program installed in the computer or embedded system from the storage medium, the OS (operating system) running on the computer, or database management software, or MW (middleware) of a network, or the like, may execute a part of each process for implementing the embodiments.

Additionally, the storage medium in the embodiments is not limited to a medium that is independent from the computer or embedded system, and may include a storage medium that downloads, and stores or temporarily stores, a program that is transmitted through a LAN, the internet, or the like.

Additionally, the number of storage media is not limited to one. Also when the process in the embodiments is executed from a plurality of storage media, such media are included in the storage medium in the embodiments, and the media may have any configuration.

Note that the computer or embedded system in the embodiments executes the processes in the embodiments, based on the program stored in the storage medium, and may have any configuration, such as an apparatus composed of any one of a personal computer, a microcomputer and the like, or a system in which a plurality of apparatuses are connected via a network.

Additionally, the computer in the embodiments is not limited to a personal computer, and may include an arithmetic processing apparatus included in information processing equipment, a microcomputer, and the like, and is a generic term for devices and apparatuses which can implement the functions in the embodiments by programs.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising a processor configured to:
acquire training data that is used for training of a first feature extractor and a second feature extractor;
determine a model size of the second feature extractor;
extract a first feature by inputting the training data to the first feature extractor;
extract a second feature by inputting the first feature to the second feature extractor; and
train the first feature extractor in such a manner as to make the first feature closer to the second feature.

2. The apparatus according to claim 1, wherein the first feature extractor and the second feature extractor have an equal number of dimensions of features that are extracted.

3. The apparatus according to claim 1, wherein pre-trained parameters in the first feature extractor are set as an initial value.

4. The apparatus according to claim 1, further comprising a storage configured to store a plurality of the second feature extractors, wherein
the processor is configured to select the second feature extractor that is used for the training, from among the plurality of the second feature extractors.

5. The apparatus according to claim 1, wherein the processor is configured to determine the model size of the second feature extractor, based on at least one of a memory size, a calculation cost, and an inference accuracy.

6. The apparatus according to claim 1, wherein each of the first feature extractor and the second feature extractor is a model using a Transformer configuration, or a model using an MLP-Mixer.

7. The apparatus according to claim 1, wherein the processor is configured to:
extract a feature of an intermediate layer of the first feature extractor as the first feature, and
extract a feature of an intermediate layer of the second feature extractor as the second feature.

8. An information processing method comprising:
acquiring training data that is used for training of a first feature extractor and a second feature extractor;
determining a model size of the second feature extractor;
extracting a first feature by inputting the training data to the first feature extractor;
extracting a second feature by inputting the first feature to the second feature extractor; and
training the first feature extractor in such a manner as to make the first feature closer to the second feature.

9. A non-transitory computer readable medium including computer executable instructions, wherein the instructions, when executed by a processor, cause the processor to perform a method comprising:
acquiring training data that is used for training of a first feature extractor and a second feature extractor;
determining a model size of the second feature extractor;
extracting a first feature by inputting the training data to the first feature extractor;
extracting a second feature by inputting the first feature to the second feature extractor; and
training the first feature extractor in such a manner as to make the first feature closer to the second feature.
